(19) United States
(12) Patent Application Publication
(10) Pub. No.: US 2015/0036850 A1
(43) Pub. Date: Feb. 5, 2015

(54) METHOD FOR FOLLOWING A SOUND SOURCE, AND HEARING AID DEVICE

(71) Applicant: SIEMENS MEDICAL INSTRUMENTS PTE. LTD., Singapore (SG)

(72) Inventor: ROLAND BARTHEL, FORCHHEIM (DE)

(21) Appl. No.: 14/449,490

(22) Filed: Aug. 1, 2014

(30) Foreign Application Priority Data
Aug. 1, 2013 (DE) 102013215131.4

(51) Int. Cl. H04R 25/00

(52) U.S. Cl. CPC H04R 25/40
USPC 381/313

(57) ABSTRACT

A method of following a sound source with a hearing aid device. The hearing aid device has a plurality of microphones, a monitoring device, a locating device, a directional device, an energy source, a controller and an electro-mechanical transducer. The directional device generates a signal with a variable directional characteristic from the microphone signals. The directional signal is monitored for an incipient acoustic signal from a sound source from a predetermined direction range. The locating device determines the direction of origin of the sound source. A predetermined directional characteristic with an orientation toward the first sound source is also set in the directional device. The locating device then determines a change in the direction of origin of the first sound source and the orientation of the directional characteristic is set based on the changed direction of origin in the directional device.

### CROSS-REFERENCE TO RELATED APPLICATION

This application claims the priority, under 35 U.S.C. §119, of German patent application DE 10 2013 215 131.4, filed Aug. 1, 2013; the prior application is herewith incorporated by reference in its entirety.

### BACKGROUND OF THE INVENTION

### Field of the Invention

The invention relates to a method for following a sound source by way of a hearing aid device and also to a hearing aid device for performing the method. The hearing aid device has a plurality of microphones, a signal processing facility, an energy source and an earpiece. The signal processing facility is configured to receive a plurality of first signals with acoustic information from the plurality of microphones and process the plurality of signals to form a second signal with a variable directional characteristic. The method includes the step of changing an orientation of a directional characteristic to a changed direction of origin of a sound source relative to the hearing aid device.

Hearing aid devices are wearable hearing apparatuses, which serve to assist people with hearing impairments. To meet the numerous individual needs, different models of hearing aid devices are available, such as behind-the-ear (BTE) hearing devices, hearing devices with an external earpiece (RIC: receiver in the canal) and in-the-ear (ITE) hearing devices, for example also concha hearing devices or canal hearing devices (ITE, CIC). The hearing devices listed by way of example are worn on the outer ear or in the auditory canal. Also available on the market are bone conduction hearing aids, implantable or vibrotactile hearing aids. With these the damaged hearing is stimulated either mechanically or electrically.

In principle hearing devices have as their key components an input transducer, an amplifier and an output transducer. The input transducer is generally an acousto-electric transducer, such as a microphone, and/or an electromagnetic receiver, such as an induction coil. The output transducer is usually implemented in the manner of an electro-acoustic transducer, e.g. a miniature loudspeaker, or in the manner of an electro-mechanical transducer, such as a bone conduction earpiece. The amplifier is generally integrated in a signal processing facility.

Hearing devices with digital signal processing frequently have a plurality of microphones and they link their output signals to form a signal with a directional characteristic, in order to emphasize sounds from specified sound sources compared with interfering noise, thus making it easier for the wearer to follow a conversation. It is currently possible to use a number of microphones to define the directional characteristic so precisely that a deviation of even a few degrees from a preferred direction causes the output level of the hearing aid device to drop significantly.

It is generally assumed here that the preferred direction corresponds to the line of sight of the wearer. The wearer of the hearing aid devices is therefore forced to orientate the hearing device and therefore his/her head rigidly in the direction of his/her conversation partner. This is almost impossible, particularly when the speaker and/or listener move(s).

Also available on the market are hearing aid devices, the directional characteristic of which can be controlled from the outside. For example the Phonak company of Switzerland has developed a method referred to as “zoomControl,” with which the directional characteristic of a hearing aid device can be influenced by a remote controller. However for this it is necessary to have the remote controller at hand, which is not always the case in every conversation situation.

### SUMMARY OF THE INVENTION

It is accordingly an object of the invention to provide a method and a device for following a sound source which overcome the disadvantages of the heretofore-known devices of this general type and which provide for a hearing aid device and a method for operating a hearing aid device that allow the wearer to follow a conversation easily in different situations.

With the foregoing and other objects in view there is provided, in accordance with the invention, a method for following a sound source with a hearing aid device. The hearing aid device has a plurality of microphones, a monitor for monitoring a signal, a locator for determining a direction of origin of the sound source, a director for generating a directional characteristic, an energy source, a controller and an electro-mechanical transducer, the director being configured to receive a plurality of first signals with acoustic information from the plurality of microphones and to process the plurality of signals to form a second signal with a variable directional characteristic. The novel method comprises the following steps:

a) monitoring the second signal for an incipient acoustic signal from a first sound source from a predetermined direction range relative to the hearing aid device using the monitor;

b) determining a direction of origin of the first sound source relative to the hearing aid device using the locator;

c) setting a predetermined directional characteristic with an orientation toward the first sound source using the controller in the director;

d) determining a change in the direction of origin of the first sound source relative to the hearing aid device using the locator; and

e) changing an orientation of the predetermined directional characteristic to the changed direction of origin of the first sound source relative to the hearing aid device in the director using the controller.

In other words, the inventive method relates to a method for following a sound source by means of a hearing aid device. The hearing aid device has a plurality of microphones, a monitoring means for monitoring a signal, a locating means for determining a direction of origin of the sound source, a directional means for generating a directional characteristic, an energy source, a controller and an electro-mechanical transducer. The directional means is designed to receive a plurality of first signals with acoustic information from the plurality of microphones and to process the plurality of first signals to form a second signal with a variable directional characteristic. The method includes the step of monitoring the second signal for an incipient acoustic signal from a first sound source from a predetermined direction range relative to the hearing aid device using the monitoring means. The method also includes the step of determining a direction of origin of the first sound source relative to the hearing aid device using the locating means. A further step of the method involves setting a predetermined directional characteristic with an orientation toward the first sound source using the controller in the directional means. The method also includes the step of determining a change in the direction of origin of the first sound source relative to the hearing aid device using the locating means. Finally the method includes the step of changing the orientation of the predetermined directional characteristic to a changed direction of origin of the first sound source relative to the hearing aid device in the directional means using the controller. An incipient acoustic signal from a first sound source here is an acoustic signal, the signal level of which is below a predetermined limit value at a first time point and above the predetermined limit value at a second, later time point. The signal level here is preferably averaged over a short time period, so that breaks between individual oscillations, sounds or words are not identified as an incipient signal. For example a speaker addressing the wearer is identified as an incipient acoustic signal.

The inventive method advantageously allows the hearing aid device to detect a sound source in a predetermined direction range, to focus the directional characteristic on the sound source and then to monitor whether the sound source moves relative to the hearing aid device and optionally to orientate the directional characteristic toward the new position of the sound source. It is therefore sufficient for the wearer of the hearing aid device to ensure once, for example at the start of the conversation, that the hearing aid device detects the sound source. If the position of the sound source then changes or the wearer of the hearing aid device moves, the inventive method ensures that the sound source remains within the focus of the directional effect of the hearing aid device and the wearer can still hear the sounds from the sound source.

With the above and other objects in view there is also provided, in accordance with the invention, a hearing aid device for following a sound source, the hearing aid device comprising:

a plurality of microphones, an energy source, and an electro-mechanical transducer;

a director for generating a directional characteristic, said director being configured to receive a plurality of first signals with acoustic information from said plurality of microphones and to process the plurality of signals to form a second signal with a variable directional characteristic;

a monitor configured for monitoring the second signal for an incipient acoustic signal from a first sound source from a predetermined direction range relative to the hearing aid device;

a locator configured for determining a direction of origin of the first sound source relative to the hearing aid device and configured for determining a change in the direction of origin of the first sound source relative to the hearing aid device;

a controller configured for setting a predetermined directional characteristic with orientation toward the first sound source for the second signal in said director, and for matching the orientation of the predetermined directional characteristic to the changed direction of origin of the first sound source relative to the hearing aid device in said director.

In one possible embodiment of the inventive method the predetermined direction range includes directions relative to the hearing aid device, which have a deviation of maximum 15 degrees from a line of sight of a wearer of the hearing aid device when the hearing aid device is worn according to the application.

It is therefore sufficient for the wearer of the hearing aid device to look at his/her conversation partner, as is the case when behaving naturally, for example at the start of a conversation. The hearing aid device then detects the conversation partner as the sound source and sets its directional characteristic in the direction of said partner, without the wearer having to perform any additional actions.

In one conceivable embodiment of the inventive method the nature and/or origin of the incipient acoustic signal is/are evaluated.

Evaluation of the incipient acoustic signal allows a distinction to be made as to whether the acoustic signal is for example speech, music or noise or whether the speech originates from a speaker or the wearer him/herself. The hearing aid device is then able to respond differently and appropriately based on the nature or origin.

In accordance with an added feature of the invention, the evaluation includes identifying a first speaker.

Then during the further course of the inventive method it can advantageously be determined for an acoustic signal whether said acoustic signal comes from the identified first speaker and the directional characteristic for example can thus be set in the direction of the first speaker.

In accordance with a possible embodiment of the inventive method provision is made, if the wearer of the hearing aid device is identified as the first sound source and as the first speaker, for the steps of determining the direction of origin of the first sound source, setting a predetermined directional characteristic with orientation toward the first sound source, determining a change in the direction of origin and changing the orientation not to be performed with reference to the wearer of the hearing aid device as the first sound source.

It is advantageous here for the hearing aid device to identify speech utterances of the wearer as part of the inventive method and not to implement settings with reference to said wearer, as it would disturb the wearer if his/her ability to hear his/her own voice were to change suddenly.

In one conceivable embodiment of the inventive method the steps of determining a change in the direction of origin and changing the orientation are repeated.

The hearing aid device therefore follows the first sound source continuously with the orientation of the directional characteristic, so that the hearing experience for the wearer does not change suddenly even if said wearer moves his/her head or the first sound source moves.

It is furthermore conceivable as a further step in one embodiment of the inventive method for the second signal to be evaluated for a termination criterion, this step being repeated in each instance with the steps of determining the change in the direction of origin and the change of orientation and, when the termination criterion occurs, repetition of the steps of determining the change in the direction of origin, changing the orientation and evaluation for a termination criterion being terminated.

The inventive method advantageously allows the following of the first sound source to be terminated in certain circumstances. This may be expedient for example when a conversion has ended and the conversation partner, who was previously the first sound source, moves away or simply stops speaking.

In one possible embodiment of the inventive method the termination criterion is defined as being that a level of the first sound source drops below a predetermined minimum level for a first predetermined termination time and at the same time the wearer of the hearing aid device is not identified as a second sound source.

It is therefore advantageously possible for the hearing aid device to terminate the tracking of the directional characteristic automatically when a conversation is ended in that the conversation partner no longer speaks for some time and at the same time the wearer of the hearing aid device also does not reply. In contrast the tracking of the directional characteristic is advantageously not terminated if the wearer of the hearing aid devices replies to the conversation partner.

In one conceivable embodiment of the inventive method the termination criterion is defined as being that a level of the first sound source drops below a predetermined minimum level for a second predetermined termination time and at the same time a speaker, who is not the wearer of the hearing aid device, is identified as a second sound source.

This also advantageously allows the hearing aid device to terminate the tracking of the directional characteristic automatically when a conversation is ended in that the conversation partner no longer speaks for some time and at the same time another speaker speaks, who is not the speaker identified as the first sound source. Because the tracking of the first sound source is terminated, the hearing aid device can start again from the beginning with the first processing step of monitoring the second signal for an incipient acoustic signal from a first sound source and to identify the second sound source and its speaker as the sound source for which the directional characteristic must be tracked.

In one conceivable embodiment of the inventive hearing aid device the hearing aid device has directional means in the form of an adaptive filter, which is designed to match the orientation of the predetermined directional characteristic to the changed direction of origin of the first sound source relative to the hearing aid device.

An adaptive filter advantageously combines identifying a change in the relative position with tracking the directional characteristic.

Other features which are considered as characteristic for the invention are set forth in the appended claims.

Although the invention is illustrated and described herein as embodied in a method and device for following a sound source, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 shows a schematic diagram of a hearing aid device;

FIG. 2 shows a schematic diagram of the functional units in a novel hearing aid device that is configured for performing the novel method;

FIG. 3 shows a schematic flow diagram of an inventive method; and

FIG. 4 shows a schematic flow diagram of an inventive method.

### DETAILED DESCRIPTION OF THE INVENTION

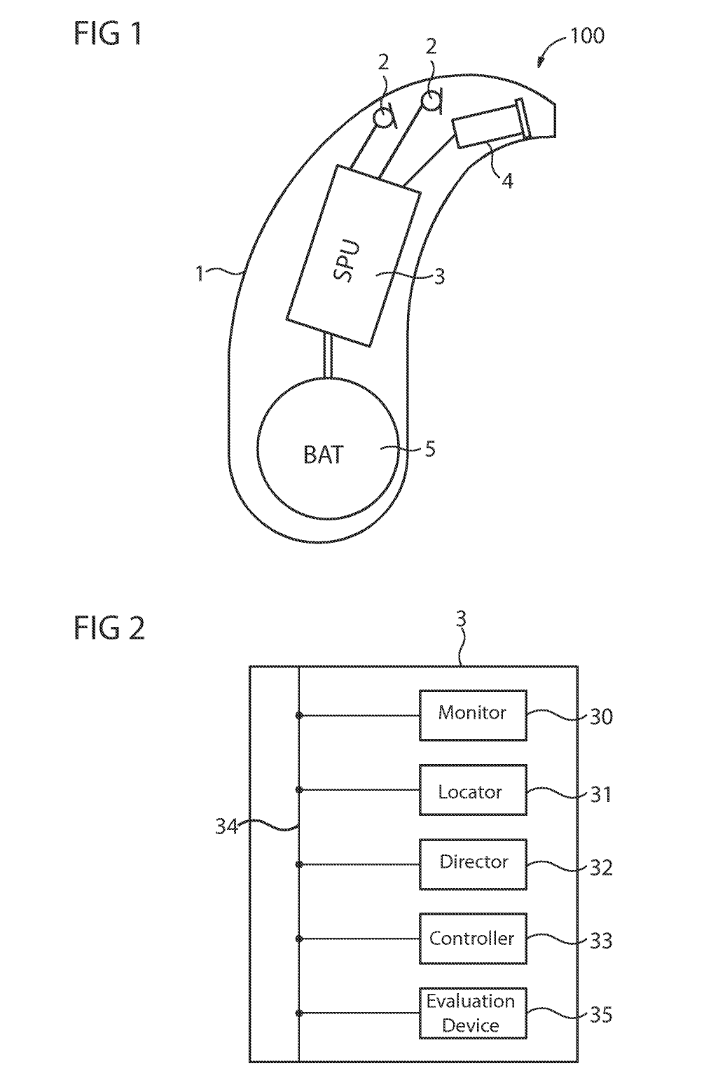

Referring now to the figures of the drawing in detail and first, particularly, to FIG. 1 thereof, there is shown the basic structure of a hearing aid device 100, here in the form of a BTE (behind-the-ear) device. Incorporated in the hearing device housing 1 to be worn behind the ear are one or more microphones 2 for receiving sound or acoustic signals from the surroundings. The microphones 2 are acousto-electric transducers 2 for converting the sound to first electrical audio signals. A signal processing facility (SPU) 3, which is also integrated in the hearing device housing 1, processes first audio signals. The output signal from the signal processing facility 3 is transmitted to a loudspeaker or earpiece 4, which outputs an acoustic signal. The sound is optionally transmitted by way of a sound tube fixed with an otoplastic in the auditory canal to the eardrum of the device wearer. However a different electro-mechanical transducer can also be used, for example a bone conduction earpiece. Energy is supplied to the hearing device and in particular to the signal processing facility 3 by a battery (BAT) 5, which is also integrated in the hearing device housing 1.

FIG. 2 shows a schematic diagram of functional units provided in the hearing aid device 100 to perform the method. These functional units are generally implemented in the signal processing facility 3 but can also be implemented as separate units in the hearing aid device.

The hearing aid device has a directional means 32, referred to herein as a director 32, which generates a signal with a directional characteristic from the first signals received from the plurality of microphones 2. To this end the electrical first signals from the microphones 2 are combined with different phasing. Subtracting two microphone signals produces a second signal with first order directional effect. By applying a time delay to a first signal it is possible to change the orientation. Combining a number of microphones allows a higher order directional effect to be achieved. The directional means 32 can also be provided by analog or digital delay elements and adders but implementation in the signal processing facility 3 is preferred. The signal processing facility 3 digitizes the electrical signals from the microphones 2 and supplies them internally to the director 32 by way of a signal bus 34.

The hearing aid device 100 also has a monitoring means 30, referred to herein as a monitor 30, which monitors the second signal. The monitor 30 receives the second signal from the directional means 32 by way of the signal bus 34. The monitor 30 determines a level of the second signal averaged over time and compares it with a predetermined limit value. If the level is above the predetermined limit value, the monitor 30 signals this by way of the signal bus 34 to the controller 33. The signal level can be determined for example by squaring the second signal and integrating it over a predetermined time period. However this could also be done using analog means in the form of a rectifier, a low pass filter and a comparator.

The hearing aid device 100 also has a locating means 31, referred to herein as a locator 31. The locator 31 is configured to determine the direction of a sound source relative to the hearing aid device 100 from the plurality of first signals from the microphones 2. This can be done two-dimensionally as a direction in a predetermined plane through the hearing aid device 100 or as a three-dimensional direction vector in relation to the hearing aid device. The sound source can be located for example by the signal processing facility 3 determining the relative phasing of the first signals from the microphones. However it would also be possible to determine the relative direction by analyzing the amplitudes or auto-correlating the first signals.

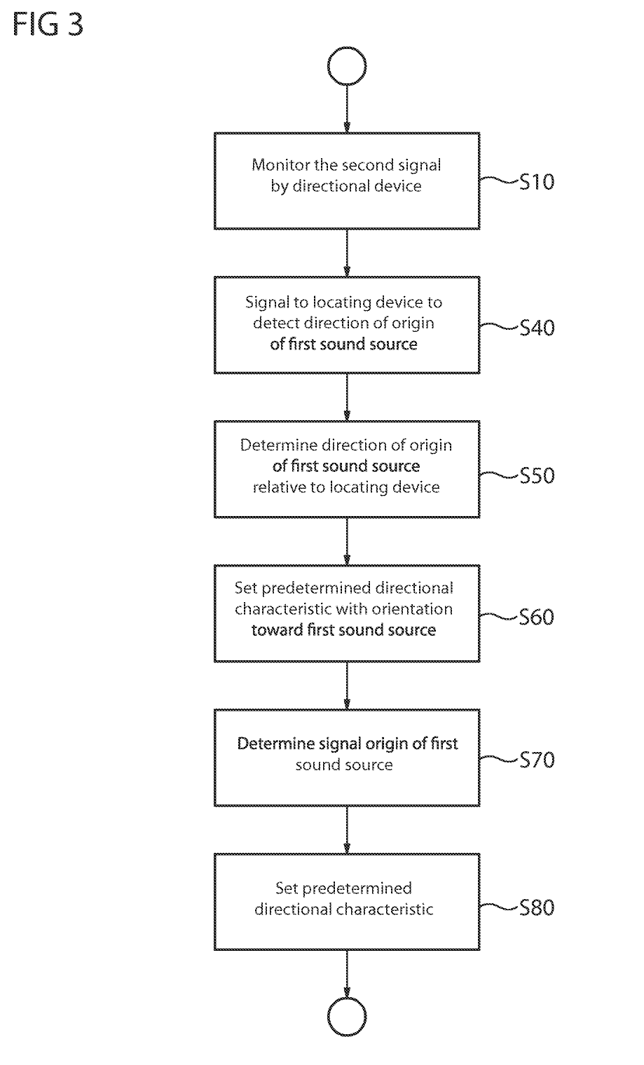

The hearing aid device 100 also has a controller 33, which sets the directional means 32 by way of the control bus 34, receives the signals from the monitoring means 30 and the locating means 31 and controls the sequence of the method illustrated in FIG. 3. The control bus 34 here can also be realized for example by a shared memory, which the cited units can access in a shared manner.

Finally the hearing aid device 100 has an evaluation device 35, which is designed to evaluate the second signal based on the nature and/or origin of the first sound source. Provision is therefore made for example for the evaluation device 35 to be designed to identify speech, for example based on a characteristic frequency distribution and/or amplitude distribution. In one possible embodiment the evaluation device is also designed to identify the wearer of the hearing aid device 100 as the sound source based on the direction of origin and/or frequency and amplitude characteristics. In one possible embodiment provision is also made for the evaluation device 35 to detect an acoustic profile characteristic of a speaker in order to identify him/her as the speaker.

In one embodiment it is conceivable for the functions of the director 32 and the locator 31 to be performed together by means of an optimization method, for example a gradient method, in the signal processing facility 3.

FIG. 3 shows a schematic flow diagram of the inventive method.

In step S10 the monitoring means 30 monitors the second signal supplied by the directional means 32. In this process the directional means 32 combines the first signals from the microphones 2 in such a manner that the signal supplied by the directional means 32 has a directional effect in a predetermined direction range relative to the hearing aid device 100. The predetermined direction range can be set for example beforehand by the controller 33 in the directional means 32. The direction range can have as the direction of the maximum directional effect for example a direction defined by a line of sight of the wearer frontally forward when the hearing aid device 100 is worn according to the application. The direction range can be defined two-dimensionally in a plane through the hearing aid device 100, for example horizontally when worn according to the application, or even three-dimensionally as a cone or club shape. The predetermined direction range can include for example a deviation of 15 degrees from the direction of the maximum directional effect. Outside this range the directional effect drops at least by a predetermined value, so that for example with a deviation of a further 5 degrees for the same sound source volume the second signal is 6 dB or even 12 dB weaker than a value the same sound source generates as a level when it is within the predetermined direction range.

The monitoring means 30 monitors the signal level of the second signal, by forming a mean value of the signal level over time. This can be done by rectifying or squaring the second signal and then integrating it over a predetermined first time period. The predetermined first time period expediently extends for a plurality of oscillations of the second signal, for example 100 ms, 500 ms, 1 s or even 2 s. If the signal level of the second signal is below a predetermined limit value at a first time point and above the predetermined limit value at a second time point, which is a predetermined second time period later, the monitoring means 30 identifies an incipient signal from a first sound source and signals this to the controller 33 by way of the signal bus 34. The predetermined second time period can be similar to the predetermined first time period but it can also be longer.

In step S40 the controller 33 signals to the locating means 31 to detect the direction of origin of the first sound source relative to the hearing aid device 100.

In step S50 the locating means 31 then determines, as described above in relation to the locating means 31, the direction of origin of the first sound source and signals this to the controller 33 by way of the signal bus 34.

In step S60 the controller 33 signals to the directional means 32 to set a predetermined directional characteristic with orientation toward the direction of origin of the first sound source. The predetermined directional characteristic here has for example a smaller angle opening or a steeper drop in sensitivity when the direction of origin deviates from the direction range. For example the angle can be 2 degrees, 5 degrees or 10 degrees for a second signal level reduced by 6 dB.

In step S70 the locating means 31 determines, as in step S50, the direction of origin of the first sound source relative to the hearing aid device 100 and signals this to the controller 33 by way of the signal bus 34, the controller 33 determining a change in the relative direction of origin. It is also conceivable for the locating means 31 itself to compare the original direction of origin with the currently determined direction of origin and for the controller 33 only to signal a changed relative direction of origin.

In step S80 the controller 33 signals to the directional means 32 to set a predetermined directional characteristic with orientation toward the changed direction of origin of the first sound source.

Another inventive possibility for performing steps S70 and S80 is an optimization method, which optimizes the signal from the first sound source without specific knowledge of the direction of origin of the first sound source. Such a method may be a gradient method for example. This is based on an approximation value or initial value of parameters of the directional means 32. There is a progression from here in the direction of the positive or negative gradient of the directional characteristic toward the parameters with changes to the parameters of the directional characteristic, until no further numerical improvement is achieved. The gradient sign is a function of how the directional characteristic is defined mathematically as a function of the parameters.

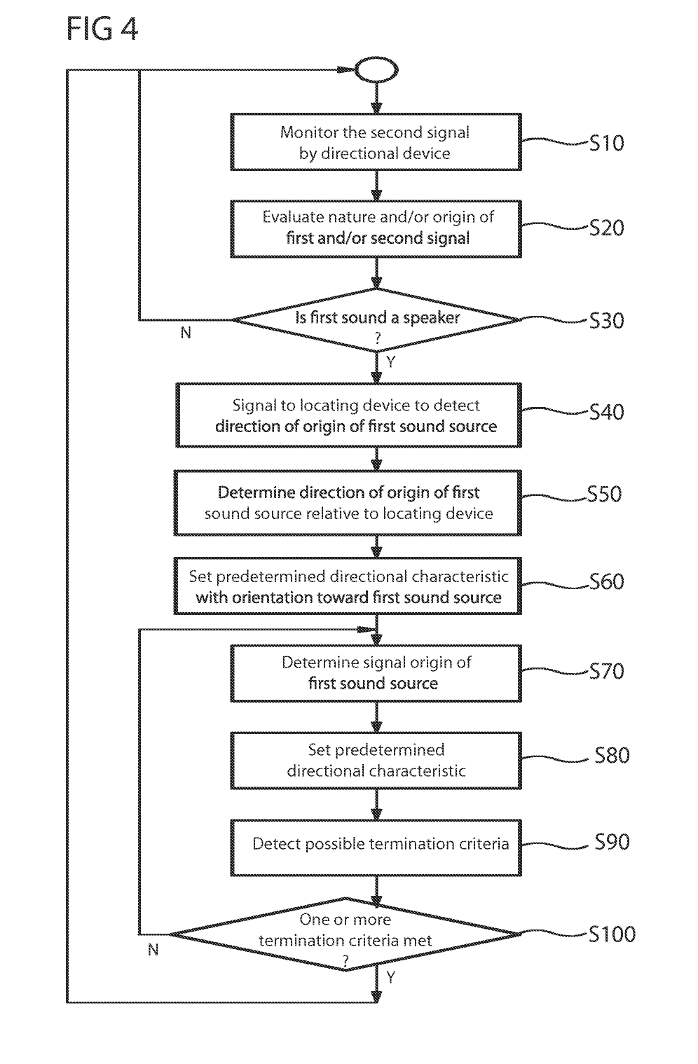

FIG. 4 shows a schematic flow diagram of an extended inventive method. Steps with the same reference character as the steps of the method illustrated in FIG. 3 are identical here.

In step S20 the evaluation device 35 evaluates the nature and/or origin of the first signals and/or the second signal, resulting from an incipient acoustic signal. In one embodiment the evaluation device 35 determines whether the first sound source is the wearer of the hearing aid device 100. This can be done based on the frequency spectrum or the direction of origin. In one embodiment it is also conceivable for the evaluation device 35 to determine whether the first sound source is a speaker. In one possible embodiment the evaluation device 35 here creates a profile on the basis of which it is possible to identify the speaker. The evaluation device 35 notifies the controller 33 of the result(s) of step S20.

In step S30 the controller 33 checks the result(s) of the evaluation by the evaluation device 35. If the first sound source is the wearer of the hearing aid device 100 or if the first sound source is not a speaker, the inventive method continues with step S10. Otherwise the inventive method continues with step S40.

The inventive method in FIG. 4 also includes the step S90.

Possible termination criteria are detected in step S90. Provision can therefore be made for example for the monitoring means 30 to continue to monitor the second signal to ascertain whether the signal level drops below a predetermined limit value for a predetermined time period.

Alternatively or simultaneously the evaluation device 35 can determine whether the sound source of the second signal is a speaker and whether said speaker is the wearer or whether the speaker is to be assigned to a profile detected in step S20. The evaluation device 35 notifies the controller 33 of the result of the evaluation by way of the signal bus 34.

In step S100 the controller 33 evaluates one or more termination criteria. One possible termination criterion is if the monitoring means 30 signals that a level of the first sound source drops below a predetermined minimum level for a first predetermined termination time and at the same time the evaluation device does not determine the wearer of the hearing aid device to be a second sound source.

It is another possible termination criterion if a level of the first sound source drops below a predetermined minimum level for a second predetermined termination time and at the same time a speaker, who is not the wearer of the hearing aid device, is identified as a second sound source.

If one or more of the termination criteria are met, the inventive method continues with step S10. If none of the termination criteria is met, the inventive method continues with step S70.

With the methods illustrated in FIGS. 3 and 4 it is possible to adjust the order of individual steps or even to change the functional distribution to the described functional units 30, 31, 32, 33 and 35 or leave out individual steps, without thereby departing from the scope of protection of the invention.

Although the invention has been illustrated and described in more detail using the preferred exemplary embodiment, the invention is not limited by the disclosed examples and other variations can be derived therefrom by the person skilled in the art without departing from the scope of protection of the invention.

1. A method for following a sound source with a hearing aid device, the method comprising:
providing the hearing aid device with a plurality of microphones, a monitor for monitoring a signal, a locator for determining a direction of origin of the sound source, a director for generating a directional characteristic, an energy source, a controller and an electro-mechanical transducer, the director being configured to receive a plurality of first signals with acoustic information from the plurality of microphones and to process the plurality of signals to form a second signal with a variable directional characteristic;
a) monitoring the second signal for an incipient acoustic signal from a first sound source from a predetermined direction range relative to the hearing aid device using the monitor;
b) determining a direction of origin of the first sound source relative to the hearing aid device using the locator,
c) setting a predetermined directional characteristic with an orientation toward the first sound source using the controller in the director;
d) determining a change in the direction of origin of the first sound source relative to the hearing aid device using the locator; and
e) changing an orientation of the predetermined directional characteristic to the changed direction of origin of the first sound source relative to the hearing aid device in the director using the controller.

2. The method according to claim 1, wherein the predetermined direction range includes directions relative to the hearing aid device that deviate by a maximum of 15 degrees from a line of sight of a wearer of the hearing aid device when the hearing aid device is worn by the wearer.

3. The method according to claim 1, which comprises evaluating a nature and/or an origin of the incipient acoustic signal.

4. The method according to claim 3, wherein the evaluating step comprises identifying a first speaker.

5. The method according to claim 4, wherein, if the wearer of the hearing aid device is identified as the first sound source and the first speaker, not performing steps b) to e) with reference to the wearer of the hearing aid device as the first sound source.

6. The method according to claim 1, which comprises repeating step d) of determining the change in the direction of origin and step e) of changing the orientation.

7. The method according to claim 6, which further comprises:
f) evaluating the second signal for a termination criterion, repeating step f) in each instance with steps d) and e); and
when the termination criterion occurs, terminating a repetition of step d) of determining the change in the direction of origin, step e) of changing the orientation and step f) of evaluating the second signal for the termination criterion.

8. The method according to claim 7, wherein the termination criterion is defined as being that a level of the first sound source drops below a predetermined minimum level for a first predetermined termination time and at the same time the wearer of the hearing aid device is not identified as a second sound source.

9. The method according to claim 7, wherein the termination criterion is defined as being that a level of the first sound source drops below a predetermined minimum level for a second predetermined termination time and at the same time a speaker, who is not the wearer of the hearing aid device, is identified as a second sound source.

10. A hearing aid device for following a sound source, the hearing aid device comprising:
a plurality of microphones, an energy source, and an electro-mechanical transducer;
a director for generating a directional characteristic, said director being configured to receive a plurality of first signals with acoustic information from said plurality of microphones and to process the plurality of signals to form a second signal with a variable directional characteristic;
a monitor configured for monitoring the second signal for an incipient acoustic signal from a first sound source from a predetermined direction range relative to the hearing aid device;
a locator configured for determining a direction of origin of the first sound source relative to the hearing aid device and configured for determining a change in the direction of origin of the first sound source relative to the hearing aid device;
a controller configured for setting a predetermined directional characteristic with orientation toward the first sound source for the second signal in said director, and for matching the orientation of the predetermined directional characteristic to the changed direction of origin of the first sound source relative to the hearing aid device in said director.

11. The hearing aid device according to claim 10, configured to perform the method according to claim 2.

12. The hearing aid device according to claim 10, wherein said director is an adaptive filter configured to match the orientation of the predetermined directional characteristic to the changed direction of origin of the first sound source relative to the hearing aid device.
